(19) United States
(12) Patent Application Publication
(10) Pub. No.: US 2006/0149394 A1
(43) Pub. Date: Jul. 6, 2006

(54) Hazard defense system and methods thereof

(75) Inventors: Joseph Patino, Pembroke Pines, FL (US); Jorge L. Perdomo, Boca Raton, FL (US); Charles P. Schultz, North Miami Beach, FL (US); Camilo E. Villamil, Pembroke Pines, FL (US)

Correspondence Address: AKERMAN SENTERFITT, P.O. BOX 3188, WEST PALM BEACH, FL, 33402-3188, US

(73) Assignee: Motorola, Inc., Schaumburg, IL (US)

(21) Appl. No.: 11/027,379

(22) Filed: Dec. 30, 2004

(51) Int. Cl. G05B 11/01

(52) U.S. Cl. 700/19; 700/20

(57) ABSTRACT

A hazard defense system (100) includes a plurality of defense elements (104), and a controller (112). Each defense element can be located in an area (101) and each element includes at least one sensor (205) for monitoring at least one hazard and defense factor, a transceiver (202), and a processor (203) coupled to the at least one sensor and transceiver. The system is programmed to monitor (302) at least one hazard and defense factor, inform (304) the controller of the at least one defense factor, detect (306) a hazard at one or more defense elements, inform (308) the controller of the hazard, establish (310) an exit strategy at the controller according to the hazard and at least one defense factor, inform (312) the plurality of defense elements of the exit strategy, and direct (314) one or more individuals out of the area according to the exit strategy.

### FIELD OF THE INVENTION

This invention relates generally to systems operating in response to emergency conditions, and more particularly to a hazard defense system and methods thereof.

### BACKGROUND OF THE INVENTION

Emergency hazard systems today fall short of providing an adaptable and holistic ingress and egress strategy for individuals in an area affected by a hazard.

The embodiments of the invention described below help to overcome this limitation in the art.

### SUMMARY OF THE INVENTION

Embodiments in accordance with the invention provide a system and method for defending against hazards.

In a first embodiment of the present invention, a hazard defense system comprises a plurality of defense elements coupled to a controller. Each defense element is located in an area. The hazard defense system includes a method comprising the steps of monitoring at least one hazard and at least one defense factor at each of the plurality of defense elements, informing the controller of the at least one defense factor from the plurality of defense elements, detecting a hazard at one or more of the plurality of defense elements, informing the controller of the hazard, establishing an exit strategy at the controller according to the hazard and the at least one defense factor from the plurality of defense elements, informing the plurality of defense elements of the exit strategy, and directing one or more individuals at each of the plurality of defense elements out of the area according to the exit strategy.

In a second embodiment of the present invention, a hazard defense system comprises a plurality of defense elements coupled to each other and each is located in an area. The hazard defense system includes a method comprising the steps of monitoring at least one hazard and at least one defense factor at each of the plurality of defense elements, detecting a hazard at one or more of the plurality of defense elements, sharing information among the plurality of defense elements including the hazard and the at least one defense factor monitored by the plurality of defense elements, establishing an exit strategy at each of the plurality of defense elements according the hazard and the at least one defense factor from the plurality of defense elements, and directing one or more individuals at each of the plurality of defense elements out of the area according to their respective exit strategy.

In a third embodiment of the present invention, a hazard defense system comprises a plurality of defense elements coupled to a controller. Each of the plurality of defense elements is located in an area, and each comprises at least one sensor for monitoring at least one hazard and at least one defense factor, a transceiver, and a processor coupled to the at least one sensor and transceiver. The hazard defense system is programmed to monitor at least one hazard and at least one defense factor at each of the plurality of defense elements, inform the controller of the at least one defense factor from the plurality of defense elements, detect a hazard at one or more of the plurality of defense elements, inform the controller of the hazard, establish an exit strategy at the controller according to the hazard and the at least one defense factor from the plurality of defense elements, inform the plurality of defense elements of the exit strategy, and direct one or more individuals at each of the plurality of defense elements out of the area according to the exit strategy.

### BRIEF DESCRIPTION OF THE DRAWINGS

FIG. 1 is an illustration of a hazard defense system operating in an area in accordance with an embodiment of the present invention.

FIG. 2 is a block diagram of a defense element of FIG. 1 in accordance with an embodiment of the present invention.

FIG. 3 is a flow chart illustrating a method operating in the hazard defense system in accordance with an embodiment of the present invention.

FIG. 4 is a flow chart illustrating an alternative embodiment of the method operating in the hazard defense system in accordance with the present invention.

### DETAILED DESCRIPTION

While the specification concludes with claims defining the features of embodiments of the invention that are regarded as novel, it is believed that the embodiments of the invention will be better understood from a consideration of the following description in conjunction with the figures, in which like reference numerals are carried forward.

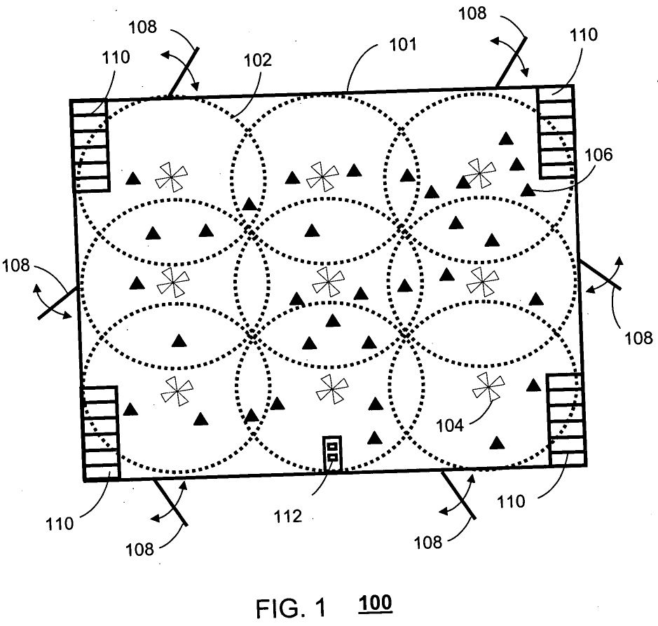

FIG. 1 is an illustration of a hazard defense system 100 operating in an area in accordance with an embodiment of the present invention. For illustration purposes only, the invention will be described according to a single structure 101 located in, for example, a metropolitan area. It will be appreciated by one of ordinary skill in the art, however, that the invention described according to the illustration of FIG. 1 can be applied to an area comprising a large park with trees, paths and/or hills with no structures 101, and/or multiple structures 101 with open spaces, which in the aggregate represent a city, a state, or other large spaces depending on how much area needs to be protected. The hazard defense system 100 protects individuals 106 in the structure 101 from hazards as will be described shortly. The structure 101 can be any conventional enclosure of one or more stories with one or more egress routes. In the present illustration, the structure 101 has at least two floors as indicated by the stairways 110. The exit doors 108 are at the ground level. However, exit doors 108 can also be at the upper floors when stairways external to the structure 101 (such as a fire escape) are provided.

In a first embodiment of the present invention, the hazard defense system 100 comprises a plurality of defense elements 104, and a controller 112 coupled thereto. The controller 112 utilizes conventional computer technology for processing information received from the defense elements 104. Communication between the controller 112 and the defense elements 104 can be accomplished using conventional wireless technology (such as IEEE 802.11), wired technology (such as Ethernet), or combinations thereof. The controller 112 can be situated in a location of the structure 101 where it is least intrusive, and more importantly, where it is least susceptible to hazards (e.g., fire proof utility room). In addition, the controller 112 can utilize a conventional battery backup system to continue operation even when conventional electricity has been interrupted.

The controller 112 can also comprise a distributed computing environment for additional redundancy. In this embodiment, conventional processing means can be distributed at each floor of the structure 101, each computing element operating in a manner that collectively provides a method of operation in accordance with embodiments of the present invention described herein.

Each of the defense elements 104 is located in the structure 101 for monitoring a site 102 on a floor of the structure 101. The defense elements 104 can be strategically located in the structure 101, positioned in an ad hoc manner in the structure 101, or positioned in the structure 101 with an overlapping sensing range, thereby providing hazard defense redundancy. Moreover, the defense elements 104 can be mobile. In a first embodiment, the defense elements 104 can employ mobility technology (such as servo motors coupled to mobile elements such as wheels included in said elements 104) thereby providing a dynamic means for said elements 104 to change the range of hazard protection coverage provided. In a second embodiment, the defense elements 104 can be carried by emergency personnel and/or individuals 106 navigating in the structure 101. These elements 104 communicate with the controller 112 wirelessly as will be described below. In a third embodiment, the defense elements 104 can be coupled to hazardous materials that can be moved by individuals 106 in the structure 101, which also can communicate with the controller 112 wirelessly.

The aggregate of all defense elements 104 operating at a particular floor provides monitoring of an area equivalent to, or nearly equivalent to, the entire surface area of the floor. This arrangement can be reproduced on each floor in order to cover all floors of a multi-level structure 101. Moreover, where there are multiple structures 101 and open areas such as large parks, the defense elements 104 can be located in these structures and open areas to protect all sites of the metropolitan area.

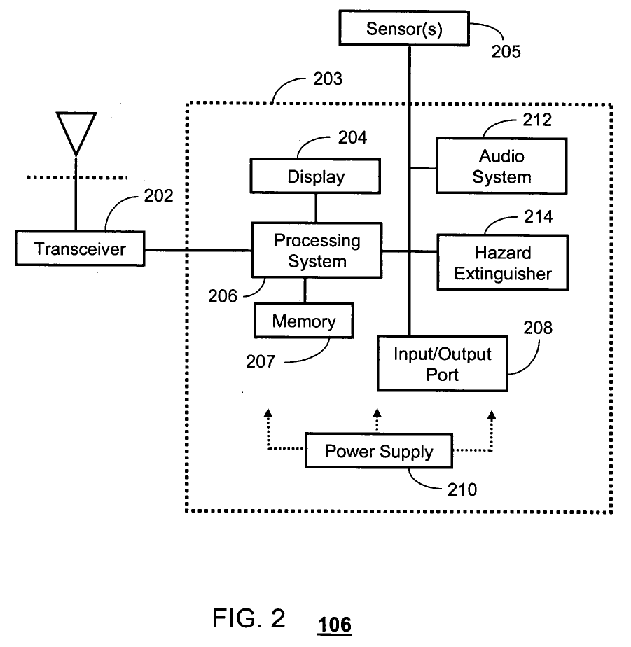

FIG. 2 provides a block diagram of a defense element 104 in accordance with an embodiment of the present invention. The defense element 104 includes at least one conventional sensor 205, a conventional transceiver 202, and a conventional processor 203.

The sensor 205 comprises one or more sensing devices for monitoring at least one hazard and at least one defense factor. In the case of hazards, the sensors 205 include technology for sensing fire, smoke, toxins of chemical or biological composition, and temperature, just to name a few. Other conventional hazard detection technology can also be used singly or in combination in the present invention. For defense factors the sensors 205 can include infrared motion detectors, wireless communication with emergency personnel, body heat sensing technology, conventional technology for sensing density of individuals 106 at a site 102, video cameras, structural sensors at or near egress areas 110, or any other sensing technology that can sense the state of individuals 106 and/or a portion of the structure 101 within a corresponding site 102 monitored by a defense element 104. The aggregate of the defense factors provides a holistic view for developing ingress and egress strategies around an area affected by a hazard.

The processor 203 can include a display 204, a processing system 206, a memory 207, an input/output port 208, an audio system 212, a power supply 210, and a hazard extinguishing system 214. It will be appreciated that the processor 203 can comprise fewer components while maintaining consistency with the scope and spirit of the claims herein. The display 204 can be co-located with the processing system 206, or can be remotely located at an egress point such as an exit door 108. Alternatively, more than one display 204 can be used. In this embodiment, each display 204 can be located at multiple positions within the corresponding site 102 of the defense element 104. Moreover, the display 204 can comprise a lighting system embedded on the floor of the structure 101 to direct individuals 106 to egress routes when there is no lighting or there is too much smoke to readily see while standing.

The audio system 212 can be co-located with the processing system 206. Alternatively, the audio system 212 can comprise multiple conventional audio elements, each distributed at strategic points in the corresponding site 102 of the defense element 104. The audio system 212 can generate audible sound, and if desired for additional protection, receive audible sound from an area covered by the corresponding site 102 of the defense element 104 so as to permit conversations between individuals 106 and emergency personnel.

The input/output port 208 allows for localized access to a defense element 104 and can be used for maintenance and control of the hazard extinguisher 214. The hazard extinguisher 214 can comprise conventional technology for eradicating hazards. For instance, the hazard extinguisher 214 can comprise a combination of hazard countermeasures such as a water extinguisher for fire hazards and ventilation system to remove smoke and/or other toxic hazard within the site 102. Components of the hazard extinguisher 214 can be strategically positioned in the corresponding site 102 of the defense element 104 to provide an optimal defense system against hazards.

The processing system 206 includes a conventional microprocessor or other like computing device for controlling operation of the defense element 104. The processing system is coupled to the memory 207, which includes software to operate the processing system 206 and to store and manipulate information in accordance with the invention. Alternatively, the processing system 206 and memory can be replaced with an ASIC (Application Specific Integrated Circuit) designed to operate according to the invention.

The transceiver 202 utilizes conventional technology to communicate interactively with the controller 112, among the defense elements 104, and individuals 106 in the structure 101. Represented by the hashed line intersecting the antenna in FIG. 2, the means used by the transceiver 202 for communication can be wireless, wired, or combinations thereof. Where wireless technology is used, the defense elements 104 can be programmed to communicate wirelessly with emergency personnel working their way through the structure 101, as well as individuals 106 carrying wireless devices capable of receiving and processing signals from the defense elements 104.

The power supply 210 utilizes conventional electric supply technology for powering the components 202-214 of the defense element 104. During normal operation, electricity is supplied to stationary defense elements 104 by way of wires carrying electricity throughout the structure 101. When electricity is interrupted, the power supply 210 can include backup batteries to supply power to the components 202-214 for a period of time sufficient to permit individuals 106 to exit the structure 101 safely, and permit emergency personnel to adequately address the hazard.

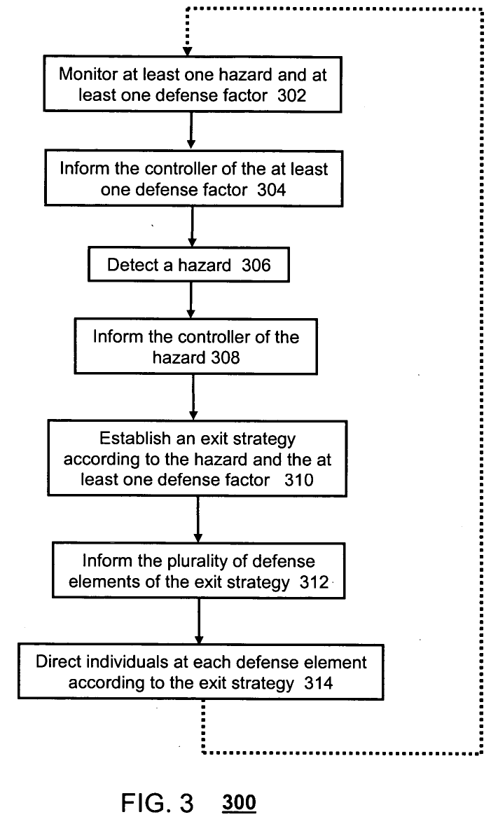

FIG. 3 is a flow chart illustrating a method 300 operating in the hazard defense system 100 in accordance with an embodiment of the present invention. The method 300 begins with step 302 where each defense element 104 is directed by its corresponding processor 203 to monitor at least one hazard and at least one defense factor. In step 304, the plurality of defense elements 104 inform the controller 112 of the defense factors. When a hazard occurs, in step 306 one or more of the defense elements 104 detects the hazard. In step 308, the controller 112 is notified of the hazard. To avoid a false positive in this step, the controller 112 can be programmed to request confirmation from several neighboring defense elements 104 within range of the affected site 102, and/or request audible confirmation from individuals 106 detected in the site 102 to be sure the hazard is real. In step 310, the controller 112 establishes an exit strategy according to the hazard and the defense factors monitored by the aggregate of mobile and stationary defense elements 104.

The exit strategy can be established according to any algorithm suitable for exiting individuals 106 from the structure 101. The algorithm for the exit strategy can be as simple as informing individuals 106 in the structure 101 where the hazard is located in the structure 101 as an avoidance factor. The individuals 106 in this embodiment then decide how to exit the structure 101 on their own accord. The algorithm can also include informing said individuals 106 by way of the defense elements 104 of the progress of the hazard and type of hazard detected.

Alternatively, from the defense factors the controller 112 can, for example, assess the density of individuals 106 at each site 102, the location of individuals 106 relative to the hazard, the structural state of an egress section such as a stairway 110 (making sure it has adequate integrity to support one or more individuals 106), smoke and toxin concentrations, temperature, and location of one or more emergency personnel, just to name a few.

From this information, the controller 112 can determine one or more routes to direct individuals 106 at each site 102. The aggregate of these routes operated in part by each defense element 104 provides an overall exit strategy for individuals in the structure 101. For multi-level areas 101, the defense factors can be processed by floor and proximity to the hazard to establish an exit strategy that addresses all floors of the structure 101.

The controller 112 in step 312 informs the defense elements 104 of the exit strategy once it has been determined. Each defense element 104 in turn directs individuals 106 out of the structure 101 in step 314 from their respective sites 102 according to the exit strategy. The controller 112 can be further programmed to direct one or more of the defense elements 104 that detected the hazard to activate any one or more hazard countermeasures such as described above.

During execution of the exit strategy, individuals 106 can be directed by the defense elements 104 by way of audible and/or visual instructions. The audible instructions can be verbal and/or audible alerts operated at the audio system 212, which individuals 106 can readily ascertain as an egress instruction. Visual instructions may be textual, graphical, and/or lights operating as an integral part of the display 204 that one or more individuals 106 can readily understand as an egress instruction. Each defense element 104 utilizes its display 204 and audio system 212 singly or in combination to execute the exit strategy.

In yet another embodiment, the controller 112 establishes a hazard defense strategy in accordance to the hazard and defense factors. The hazard defense strategy can comprise instructions communicated by the controller 112 that direct one or more emergency personnel (such as firemen) on a proposed manner to eradicate the hazard. Alternatively, the hazard defense strategy can simply involve directing emergency personnel to the hazard. In addition, the controller 112 can inform a remote controller located outside the structure 101 (not shown in FIG. 1) of any one or more of the conditions monitored by the defense elements 104.

Such conditions can be presented visually to an administrator of the remote controller by way of a graphical representation of the structure 101 showing density of individuals at each site 102, motion of such individuals as they exit the structure 101, location of the hazard, type of hazard, and so on. Moreover, the controller 112 can communicate the hazard defense strategy to the defense elements 104, which in turn can direct emergency personnel audibly, visually, or wirelessly while in the structure 101. As a supplemental embodiment, the hazard defense strategy can also include management of traffic control systems (such as street lights) by way of the controller 112 or remote controller in order to provide emergency personnel a rapid emergency vehicular egress and ingress strategy for addressing the hazard. The controller 112 (or remote controller coupled thereto) can adjust traffic management according to developments sensed by the defense elements 104 in the structure 101 and in open areas as the case may be.

In yet another embodiment, the defense elements 104 include as a defense factor the ability to detect a malfunction in the controller 112. Such a malfunction can occur from an interruption in communications between the controller 112 and the defense elements 104, or other form of disruption such as destruction of the controller 112 by the hazard. As a first order of defense, a defense element 104 can communicate with a neighboring defense element 104 to relay messages to the controller 112 in the event other defense elements 104 are still in communication with the controller 112.

Alternatively, if other defense elements 104 cannot detect the controller 112 as well, the defense elements 104 can revert to a distributed defense method. In this embodiment, the defense elements 104 share information including the hazard and the defense factors. The intercommunication between defense elements 104 can be wireless, wired or combinations thereof. From the information shared, the defense elements 104 establish an exit strategy at each of their respective sites 102 and direct one or more individuals 106 out of the structure 101 according to said strategy.

In this embodiment, each exit strategy can be a sub element of a complex strategy developed from coordination among the defense elements 104, which holistically emulates the algorithm used by the controller 112. Alternatively, each exit strategy can be processed in a decentralized manner, whereby each defense element 104 determines the optimal exit strategy for individuals in its site 102. Either approach can be used singly or in combination depending on the processing ability of the defense elements 104.

Similarly, the controller 112 can be programmed to detect malfunctions in one or more of the defense elements 104. Malfunctions can include loss or intermittent communications between the affected defense element 104 and the controller 112, destruction of the defense element 104 or other form of interruption detectable by the controller 112. Upon detecting such an event, the controller 112 establishes an updated exit strategy according to the malfunction. The updated exit strategy can include, for example, avoidance of the site 102 of the affected defense element(s) 104, or communicating with one or more neighboring defense elements 104 that have an overlapping range of sensitivity with the site 102 of the affected defense element 104 to assess the state of said site 102. In an embodiment where the defense elements 104 are mobile, the controller 112 can also inform one or more defense elements 104 neighboring the affected defense elements 104 to move position so as to expand the scope and range of detection to the site 102 of said affected elements 104. The updated exit strategy is communicated to the unaffected defense elements 104, which in turn direct individuals 106 out of the structure 101 accordingly.

To supplement the foregoing embodiments, the defense elements 104 and controller 112 can be programmed to repeatedly monitor and update the exit strategy as shown in FIG. 3. Updating the exit strategy can occur for any number of reasons including detection by the defense elements 104 that a number of individuals 106 in corresponding sites 102 are not following the exit strategy as directed, the hazard has progressed in such a manner that the exit strategy warrants updating, bottlenecks of individuals 106 have formed at particular egress points, destruction or interruption in operation of one or more defense elements 104 or the controller 112 has occurred, and so on.

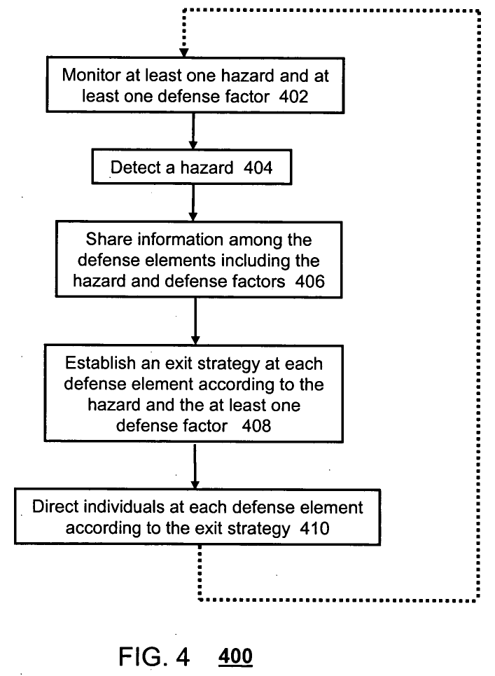

In a second embodiment of the present invention, the hazard defense system 100 can be devised as a distributed system exclusive of a controller 112. In this embodiment, the hazard defense system 100 comprises a plurality of defense elements 104 coupled to each other by conventional wires, conventional wireless technology, or combinations thereof. Each defense element 104 is also positioned in the structure 101 to optimally monitor all, or nearly all, portions of the structure 101. The hazard defense system 100 operates according to a method 400 illustrated in FIG. 4 in accordance with an embodiment of the present invention. The method 400 begins with step 402 where each of the defense elements 104 monitors hazards and defense factors as described in method 300. When a hazard is detected in step 404 the defense elements 104 share information in step 406 including the hazard and defense factors. Information sharing between the defense elements 104 of the hazard and/or the defense factors can be applied to the method 400 as frequently as desired.

From the shared information, each defense element 104 establishes a corresponding exit strategy in step 408. These individual exit strategies can in the aggregate comprise a holistic exit strategy similar to the centralized exit strategy generated by the controller 112 operating according to method 300 and its corresponding supplemental embodiments. Alternatively, each defense element 104 can develop an exit strategy that is optimal to the information it has received from its neighboring defense elements 104. In either of the foregoing embodiments, the exit strategy can be chosen from a list of predetermined exit strategies stored in the memory 207 of each of the defense elements 104. The selection criteria for the list of exit strategies can be driven by the information shared by the defense elements 104.

Upon establishing an exit strategy, in step 408, each of the defense elements 104 begins in step 410 to direct individuals 106 within its corresponding site 102 out of the structure 101. Exit directions can be relayed to individuals 106 audibly or visually according to the embodiments described above. The embodiments for activating hazard countermeasures at the defense elements 104 for eradicating the hazard, and the steps of establishing a hazard defense strategy for directing emergency personnel are also applicable to method 400. Moreover, the defense elements 104 can also be programmed to detect a malfunction in neighboring defense elements 104. Under such conditions, the defense elements 104 can generate an updated exit strategy similar to the way malfunctions were addressed above for the method 300.

As shown in FIG. 4, the steps in method 400 and its supplemental embodiments can be repeated to provide the defense elements 104 a means to adapt their respective exit strategy according to updates in the egress of individuals 106 and progress of the hazard in the structure 101.

In light of the foregoing description, it should be recognized that embodiments in the present invention could be realized in hardware, software, or a combination of hardware and software. These embodiments could also be realized in numerous configurations contemplated to be within the scope and spirit of the claims below. It should also be understood that the claims are intended to cover the areas described herein as performing the recited function and not only structural equivalents.

For example, although wired communications and wireless communications between components of the hazard defense system 100 may not be structural equivalents in that wired communications employ a physical means for communicating between devices (e.g., copper or optical cables), while wireless communications employ radio signals for communicating between devices, a wired communication system and a wireless communication system achieve the same result and thereby provide equivalent areas. Accordingly, equivalent areas that read on the description are intended to be included within the scope of the invention as defined in the following claims.

What is claimed is:

1. In a hazard defense system comprising a plurality of defense elements coupled to a controller, each defense element located in an area, a method comprising the steps of:
monitoring at least one of a hazard and a defense factor at the plurality of defense elements;
informing the controller of the at least one defense factor from the plurality of defense elements;
detecting a hazard at one or more of the plurality of defense elements;
informing the controller of the hazard;
establishing an exit strategy at the controller according to the hazard and the at least one defense factor from the plurality of defense elements;
informing the plurality of defense elements of the exit strategy; and
directing one or more individuals at each of the plurality of defense elements out of the area according to the exit strategy.

2. The method of claim 1, further comprising the step of activating a hazard countermeasure at the one or more defense elements to eradicate the hazard in whole or in part.

3. The method of claim 1, wherein the one or more individuals are directed according to a select one or more of audible instructions and visual instructions.

4. The method of claim 1, further comprising the step of repeating the aforementioned steps to capture updates and make adjustments accordingly.

5. The method of claim 1, wherein the at least one defense factor comprises at least one of a group of monitored conditions in the area comprising progress of the hazard, toxin concentrations, temperature, location of one or more individuals, density of individuals, egress routes, location of one or more emergency personnel, state of controller, and structural conditions.

6. The method of claim 5, wherein the exit strategy is established according to a select one or more of the group of monitored conditions captured by the plurality of defense elements.

7. The method of claim 1, further comprising the steps of:
establishing a hazard defense strategy at the controller according to the hazard and the at least one defense factor from the plurality of defense elements; and
directing one or more emergency personnel according to the hazard defense strategy.

8. The method of claim 5, further comprising the steps of:
informing a remote controller located outside of the area of the group of monitored conditions captured by the plurality of defense elements; and
presenting the group of monitored conditions to an administrator of the remote controller.

9. The method of claim 7, further comprising the step of directing management of traffic control systems from the controller according to the hazard defense strategy to provide emergency personnel a vehicular egress and ingress strategy for addressing the hazard.

10. The method of claim 1, wherein the plurality of defense elements are coupled to each other, and where the method further comprises the steps of:
detecting at the plurality of defense elements a malfunction in the controller; and
reverting to a distributed defense method comprising the steps of:
sharing information among the plurality of defense elements including the hazard and the at least one defense factor monitored by the plurality of defense elements;
establishing an exit strategy at each of the plurality of defense elements according the hazard and the at least one defense factor from the plurality of defense elements; and
directing one or more individuals at each of the plurality of defense elements out of the area according to their respective exit strategy.

11. The method of claim 1, further comprising the steps of:
detecting at the controller a malfunction in one or more of the plurality of defense elements;
establishing an updated exit strategy according to the malfunction;
informing the plurality of defense elements of the updated exit strategy; and
directing one or more individuals at each of the plurality of defense elements out of the area according to the updated exit strategy.

12. In a hazard defense system comprising a plurality of defense elements coupled to each other and each located in an area, a method comprising the steps of:
monitoring at least one of a hazard and a defense factor at the plurality of defense elements;
detecting a hazard at one or more of the plurality of defense elements;
sharing information among the plurality of defense elements including the hazard and the at least one defense factor monitored by the plurality of defense elements;
establishing an exit strategy at each of the plurality of defense elements according the hazard and the at least one defense factor from the plurality of defense elements; and
directing one or more individuals at each of the plurality of defense elements out of the area according to their respective exit strategy.

13. The method of claim 12, further comprising the step of choosing the exit strategy from a list of predetermined exit strategies according to the information shared among the plurality of defense elements.

14. The method of claim 12, further comprising the step of activating a hazard countermeasure at the one or more defense elements to eradicate the hazard in whole or in part.

15. The method of claim 12, wherein the one or more individuals are directed according to a select one or more of audible instructions and visual instructions, and wherein the method further comprises the step of repeating the aforementioned steps to capture updates and make adjustments accordingly.

16. The method of claim 12, wherein the at least one defense factor comprises at least one of a group of monitored conditions in the area comprising progress of the hazard, toxin concentrations, temperature, location of one or more individuals, density of individuals, egress routes, location of one or more emergency personnel, state of controller, and structural conditions, and wherein the exit strategy is established according to a select one or more of the group of monitored conditions captured by the plurality of defense elements.

17. The method of claim 12, further comprising the steps of:
establishing a hazard defense strategy at each of the plurality of defense elements according to the information shared by the plurality of defense elements; and
directing one or more emergency personnel at each of the plurality of defense elements according to the hazard defense strategy.

18. The method of claim 16, further comprising the steps of:
informing a remote controller located outside of the area of the group of monitored conditions captured by the plurality of defense elements; and
presenting the group of monitored conditions to an administrator of the remote controller.

19. The method of claim 12, further comprising the steps of:
detecting at a portion of the plurality of defense elements a malfunction in one or more of the plurality of defense elements;
establishing an updated exit strategy at each of the portion of the plurality of defense elements according to the malfunction;
directing one or more individuals at each of the portion of the plurality of defense elements out of the area according to their respective updated exit strategy.

20. A hazard defense system, comprising:
a plurality of defense elements; and
a controller coupled to the plurality of defense elements;
wherein each of the plurality of defense elements is located in an area, and wherein each of the plurality of defense elements comprises:
at least one sensor for monitoring at least one of a hazard and a defense factor;
a transceiver; and
a processor coupled to the at least one sensor and the transceiver; and wherein the hazard defense system is programmed to:
monitor at least one of a hazard and a defense factor at the plurality of defense elements;
inform the controller of the at least one defense factor from the plurality of defense elements;
detect a hazard at one or more of the plurality of defense elements;
inform the controller of the hazard;
establish an exit strategy at the controller according to the hazard and the at least one defense factor from the plurality of defense elements;
inform the plurality of defense elements of the exit strategy; and
direct one or more individuals at each of the plurality of defense elements out of the area according to the exit strategy.
